(19) United States
(12) Patent Application Publication
(10) Pub. No.: US 2003/0154308 A1
(43) Pub. Date: Aug. 14, 2003

(54) General purpose compression proxy system and method for extensible markup language (XML) documents

(75) Inventors: Victor Tang, Vancouver (CA); David Rowley, Burnaby (CA)

Correspondence Address: FOLEY & LARDNER, 777 EAST WISCONSIN AVENUE, SUITE 3800, MILWAUKEE, WI, 53202-5308, US

(73) Assignee: Infowave Software, Inc.

(21) Appl. No.: 10/074,650

(22) Filed: Feb. 13, 2002

(51) Int. Cl. G06F 15/16

(52) U.S. Cl. 709/247; 709/202

(57) ABSTRACT

The system and method herein involve use of a proxy to translate between compressed and uncompressed documents. The proxy uncompresses compressed documents from a client and forwards the uncompressed version to a specified server. The response from the server goes to the proxy which compresses the document from the server before communicating it to the client. The server can dynamically generate code space for the uncompressed server response to the client, if needed, and supply it to the proxy.

### FIELD OF THE INVENTION

The present invention relates generally to computer communication methods and systems. Further, an exemplary embodiment of the present invention relates to a general purpose compression proxy system and method for extensible markup language (XML) documents.

### BACKGROUND OF THE INVENTION

Communication among clients and servers can include the transmission of documents in a variety of data formats. One example format of such documents is extensible markup language (XML). XML documents can be communicated to and from clients and servers. Some applications can require that XML documents be compressed for communication over a lower bandwidth network, such as, a wireless network. Alternatively, XML documents are compressed to optimize transfers of large XML documents, such as for electronic business transactions. The same is true for some non-XML documents or data in other formats.

Documents or data, such as XML documents or data, can be communicated using Remote Procedure Call (RPC) protocols. One known RPC method is Simple Object Access Protocol (SOAP). SOAP is a set of conventions for invoking code using XML over HTTP. The SOAP protocol specification mandates the use of a small number of HTTP headers to facilitate firewall/proxy filtering. The SOAP specification also mandates an XML vocabulary that is used for representing method parameters, return values, and exceptions.

A major drawback to SOAP is that it is verbose, particularly for low bandwidth applications, such as wireless networks. However, servers generally only understand and speak SOAP.

Thus, there is a need for a system for and a method of transmitting compressed data over a low bandwidth network and still access a SOAP network. Further, there is a need for a general purpose compression proxy system and method for extensible markup language (XML) documents. Even further, there is a need to facilitate communication between clients and servers where the client communicates data in a format not readily acceptable by the server.

The teachings hereinbelow extend to those embodiments which fall within the scope of the appended claims, regardless of whether they accomplish one or more of the above-mentioned needs.

### SUMMARY OF THE INVENTION

The present invention relates to a system and method involving the use of a proxy to translate between compressed and uncompressed documents. The proxy uncompresses compressed documents from a client and forwards the uncompressed version to a specified server. The response from the server goes to the proxy which compresses the document from the server before communicating it to the client. The server can dynamically generate code space for the uncompressed server response to the client, if needed, and supply it to the proxy.

An exemplary embodiment relates to a method of communicating between a client and a server. If communication is from the client to the server, the method includes receiving compressed data at a proxy, decompressing the received compressed data, and communicating the uncompressed data to a specified server. If communication is from the server to the client, the method includes receiving uncompressed data at the proxy, compressing the received uncompressed data, and communicating the compressed data to the client.

Another exemplary embodiment relates to a compression proxy process including receiving a compressed request from a client where the compressed request includes an XML document, determining if code space corresponding to the XML document is available, decompressing the XML document when the proxy has the correct code space, communicating the decompressed XML document to a specified server, communicating a server response from the specified server, determining if code space is available to compress the reply, dynamically generating a new code space if code space is not available to compress the reply, compressing the reply if code space is available to compress the reply or after the new code space is generated, and communicating the compressed reply including a code space version or identification header to the client.

Another exemplary embodiment relates to a method of communicating documents from a client communicating compressed documents to a server communicating decompressed documents. This method can include communicating a compressed request from a client to a proxy, decompressing the compressed request at the proxy and communicating the decompressed request to a server, communicating a response from the server to the proxy, compressing the response at the proxy and communicating the response to the client, and processing the response at the client.

Other features and advantages of embodiments of the present invention will become apparent to those skilled in the art upon review of the following drawings, the detailed description, and the appended claims.

### BRIEF DESCRIPTION OF THE DRAWINGS

The invention is illustrated by way of example and not limitation using the FIGURES of the accompanying drawings, in which like references indicate similar elements and in which:

FIG. 1 is a general block diagram of a compression proxy system and method for extensible markup language (XML) documents in accordance with an exemplary embodiment;

FIG. 2 is a flow diagram illustrating a method of communicating compressed data and documents between clients and servers in accordance with an exemplary embodiment;

FIG. 3 is a flow diagram illustrating a method of communicating compressed information between a client and a server; and

FIG. 4 is a diagrammatic representation of a wireless network including a web service in accordance with an exemplary embodiment.

### DETAILED DESCRIPTION OF THE EXEMPLARY EMBODIMENTS

A general purpose compression proxy system and method for extensible markup language (XML) documents are described herein. In the following description, for purposes of explanation, numerous specific details are set forth to provide a thorough understanding of exemplary embodiments of the invention. It will be evident, however, to one skilled in the art that the invention may be practiced without these specific details. In other instances, structures and devices are shown in diagram form to facilitate description of the exemplary embodiments.

In one embodiment, a computer system is used which has a processing unit or central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

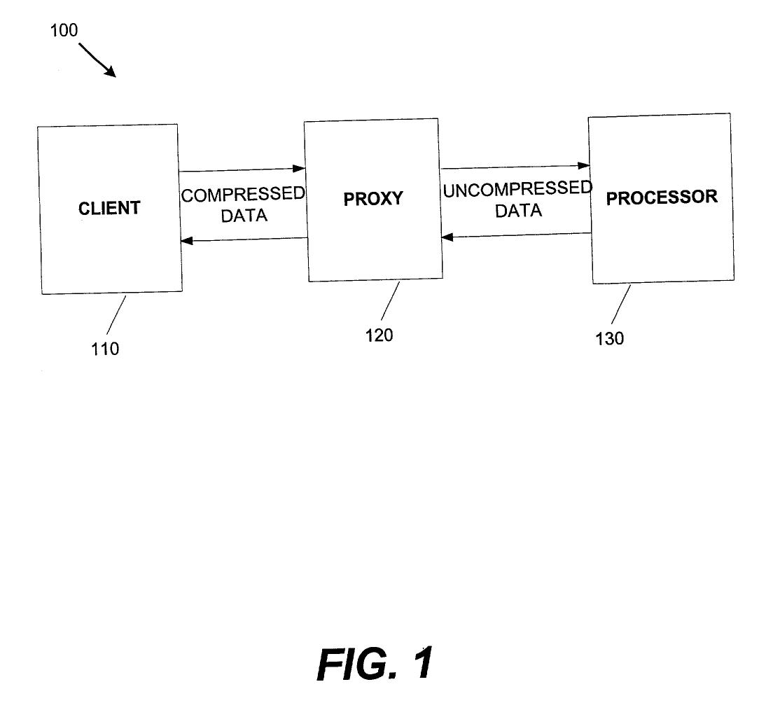

FIG. 1 illustrates a system 100 in which a client 110 communicates information to a proxy 120 and proxy 120 communicates information to a server 130. Likewise, server 130 can communicate information to proxy 120 and proxy 120 can communicate information to client 110.

Client 110 can be a wireless cellular digital phone (e.g., a WAP phone), a handheld personal digital assistant, a two-way text messaging device (e.g., two-way pager), a laptop computer, a handheld computer, a desktop computer, or any other device configured for communication over a network. Client 110 can communicate compressed documents, such as, XML documents to proxy 120.

Proxy 120 can be a computer, computer server, or any other computing device coupled to a network for communication to and from client 110 and server 130. Proxy 120 is configured to include instructions to compress and decompress documents or data. Proxy 120 can also dynamically generate code space of uncompressed server responses. Server 130 can be a computer server coupled to a network for communication with proxy 120. Server 130 is configured for communications involving uncompressed documents or data.

In an exemplary embodiment, client 110 can communicate a compressed XML document to proxy 120 with an indication of a destination server recipient. In this original client request, headers can be included indicating the address of the intended server and a code space or dictionary version or identification (ID). Proxy 120 translates the compressed XML document to an uncompressed XML document and communicates the uncompressed XML document to server 130. This translation is transparent to client 110 and server 130.

Server 130 can respond to the communication received from proxy 120 by communicating information to proxy 120. Upon receiving a communication from server 130, proxy 120 generates code space or a dictionary of the uncompressed server response. This code space or dictionary can be provided to client 110, if required. Proxy 120 can also obtain code space of the request from client 110, if required.

By way of example, client 110 sends a request through proxy 120 to server 130 having an XML document or a document in XML format. Proxy 120 receives the document, and examines the headers. If code space is not available, server 130 responds to client 110 with a request for the code space. A code space provides a translation dictionary to translate a compressed token to an uncompressed text phrase. Client 110 replies with the requested data. When proxy 120 has the correct code space, the document can be decompressed, and forwarded to server 130. The original headers are stripped of proxy specific information. All of the other headers remain untouched, especially any authentication information.

Server 130 processes the request and returns the response to proxy 120. Proxy 120 then determines if a code space exists to compress the reply. If not, proxy 120 dynamically generates a new code space, and supply it with a new version or ID. The reply is then compressed with the correct code space, and a code space version or ID header is generated, and included in the response to client 110. The compressed document is sent to client 110, and processed. Client 110 determines from the proxy header if it already has the correct code space to decompress the document it has received. If not, it must request one from proxy 120. The document can be decompressed and processed, or natively processed.

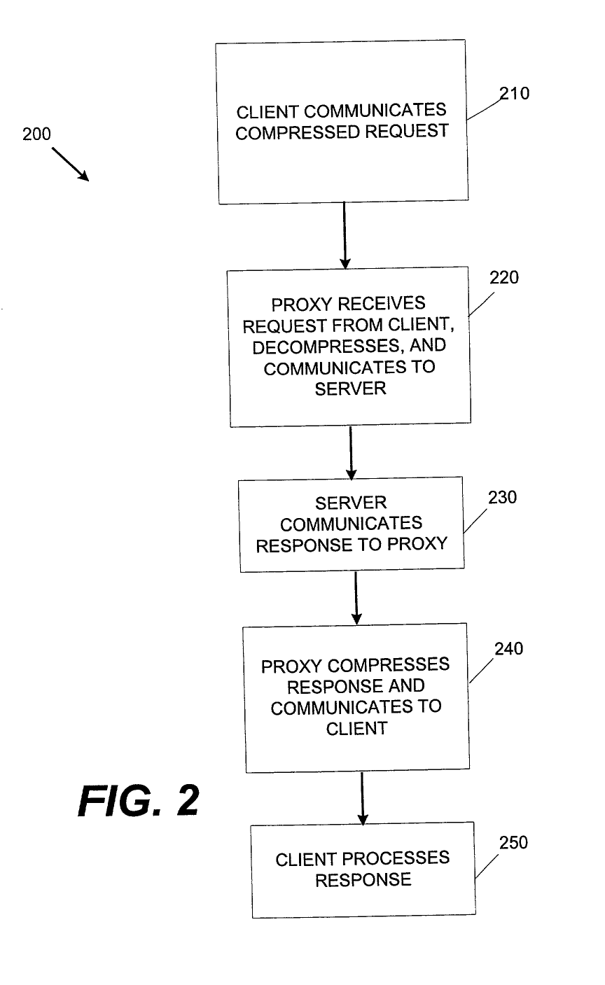

FIG. 2 illustrates a flow diagram 200 of an exemplary compression proxy process. Flow diagram 200 illustrates by way of example some steps that may be performed. Additional steps, fewer steps, or combinations of steps may be utilized in various different embodiments.

In a step 210, a client communicates a compressed request. Such a compressed request can be a XML document request or a request for any other document type. In a step 220, a proxy receives the compressed request from the client, decompresses the compressed data, and communicates the decompressed data to an appropriate destination server. Any number of compression techniques can be employed. For example, compression techniques, such as, wbXML or Millau can be used. Bulk compression techniques that are unaware of the XML document structure and do not require any code space handling, such as Zlib, Huffman, and LZM can also be used.

In a step 230, the server communicates a response to the communication received from the proxy. Such a response from the server is generally uncompressed. In a step 240, the proxy compresses the server response and communicates the compressed response to the client. In a step 250, the client processes the server response. Decompression techniques can include wbXML or Millau or other compression techniques operating in reverse.

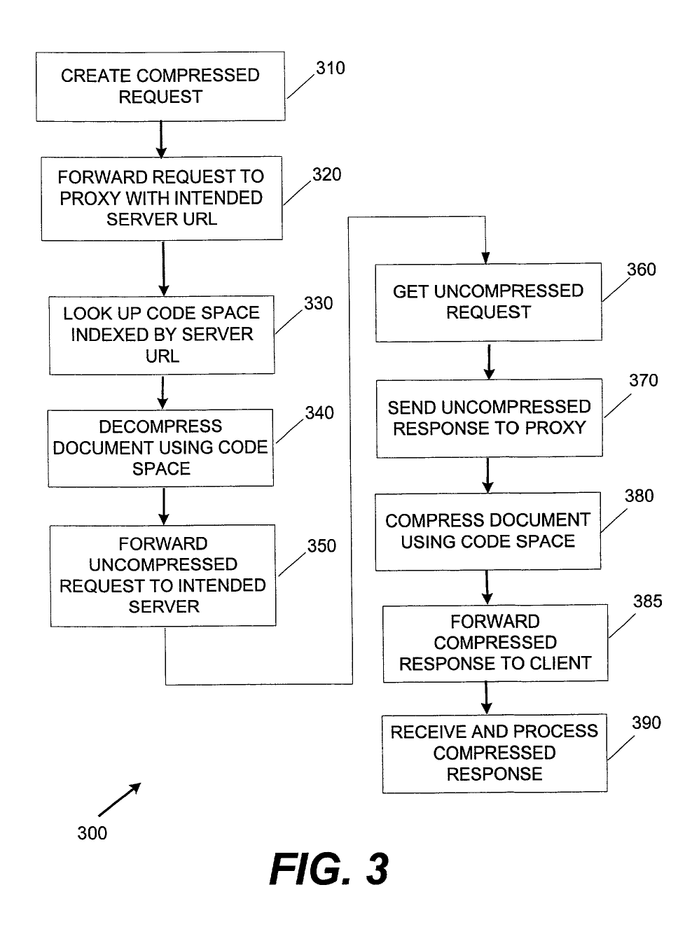

FIG. 3 illustrates a flow diagram 300 of exemplary steps in a method of communicating compressed information between a client and a server. Flow diagram 300 illustrates by way of example some steps that may be performed. Additional steps, fewer steps, or combinations of steps may be utilized in various different embodiments.

In a step 310, a client creates a compressed request. The compressed request can be a request for a document, such as, an XML document to be communicated over a network from a certain server. In a step 320, the client forwards to a proxy the intended server URL (uniform resource locator) or network address.

Upon receiving a request from the client, the proxy looks up code space indexed according to the server URL in a step 330. Code space can be identified using headers in the communication from the client to the proxy. In an alternative embodiment, the code space can be included in the message communicated from the client to the proxy. As such, versioning is not necessary.

If the code space is not available, the server responds to the client with a request for the code space. The client can reply with the requested data.

In a step 340, the proxy decompresses the document contained the code space. Any number of compression techniques can be employed. As discussed above with reference to FIG. 2, where the document is an XML document, techniques such as wbXML or Millau can be used. Bulk compression techniques can also be used.

In a step 350, the proxy forwards an uncompressed request to the intended server. In an exemplary embodiment, the original headers are stripped of proxy specific information. All other headers remain untouched, especially authentication information.

In a step 360, the server receives the uncompressed request from the proxy and, in a step 370, an uncompressed response is communicated to the proxy. The proxy determines if a code space exists to compress the response. If the code space is not available, the proxy dynamically generates a new code space and supplies it with a new version or identifier (ID).

The proxy compresses the document from the server using code space in a step 380. The document is compressed using the correct code space and a code space version or ID header, which is included in the response to the client.

In a step 385, the proxy communicates the compressed response to the client. In a step 390, the client receives and processes the response. The client determines from the proxy header if the client already has the correct code space to decompress the received document.

A header can be understood as a prelude to an HTML request that helps describe the contents of the HTML request so that it may be processed correctly. An example of an existing HTML header is: “Content-Length: 650”. This particular header describes how long the request package is. In an exemplary embodiment, a header, such as “Compression-Proxy: CodeSpaceVersion=request:005, ProxyVersion=1.0, DestinationURL=www.infowave.com/SOAP.po” can be suitable. The codespace version attribute can specify the version of the dictionary to be used for www.infowave.com/soap.po. The proxy version can state the minimum proxy version required to handle the request. The destination URL is the intended server to receive the request.

If the client does not already have the correct code space, the correct code space must be requested from the proxy server. The document can then be decompressed, processed, or natively processed.

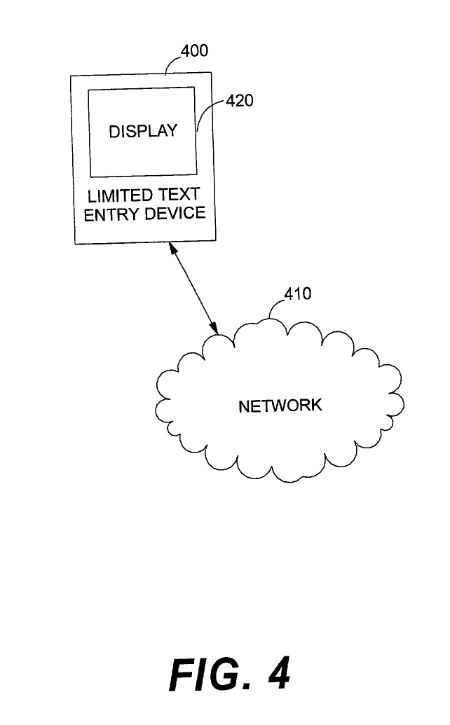

FIG. 4 illustrates a device 400 configured to communicate with a network 410. Device 400 can be a wireless cellular digital phone (e.g., a WAP phone), a handheld personal digital assistant, a two-way text messaging device (e.g., two-way pager), a laptop computer, a handheld computer, or any other such device. Although device 4000 is shown as a limited text entry device, principles of the present invention can also be utilized with devices that have full keyboard interfaces.

In an exemplary embodiment, network 410 is the Internet, a worldwide network of computer networks that use various protocols to facilitate data transmission and exchange. Network 410 can use a protocol, such as, the TCP/IP network protocol or the DECnet, X.25, and UDP protocols. In alternative embodiments, network 410 is any type of network, such as, a virtual private network (VPN), an Internet, an Ethernet, or a Netware network. Further, network 410 can include a configuration, such as, a wireless network, a wide area network (WAN) or a local area network (LAN). Network 410 preferably provides communication with Hypertext Markup Language (HTML) Web pages.

Device 400 includes a display 420 that is configured to present textual and graphical representations. Display 420 can be a monochrome, black and white, or color display and can be configured to allow touch screen capabilities. Display 420 includes a limited real estate space for presenting information. Depending on the type of device 400, display 420 can have a wide variety of different dimensions. By way of example, display 420 is a WAP phone display having twelve horizontal lines of text capability. In alternative embodiments, display 420 can include more or fewer lines of text and graphics capability.

Device 400 can request an XML document over network 410. The request can advantageously be compressed for transmission over network 410. The request can be received and uncompressed by a proxy for communication to a server as described with reference to FIGS. 1-3. Device 400 can then receive the compressed XML document requested. XML documents can include maps, word processing documents, spreadsheets, web pages, and a variety of other documents.

While the embodiments illustrated in the FIGURES and described above are presently preferred, it should be understood that these embodiments are offered by way of example only. Other embodiments may include additional procedures or steps not described here. The invention is not limited to a particular embodiment, but extends to various modifications, combinations, and permutations that nevertheless fall within the scope and spirit of the appended claims.

What is claimed is:

1. A method of communicating between a client and a server, the method comprising:
if communication is from the client to the server,
receiving compressed data at a proxy;
decompressing the received compressed data; and
communicating the uncompressed data to a specified server;
if communication is from the server to the client,
receiving uncompressed data at the proxy;
compressing the received uncompressed data; and
communicating the compressed data to the client.

2. The method of claim 1, wherein the data is an extensible markup language (XML) document.

3. The method of claim 2, further comprising examining headers of the XML document.

4. The method of claim 1, wherein the proxy dynamically generates code space of uncompressed server responses.

5. The method of claim 1, wherein the proxy obtains code space of a request from the client.

6. The method of claim 1, wherein the client is a wireless device.

7. The method of claim 1, wherein the wireless device is a cell phone.

8. The method of claim 1, wherein the proxy removes any proxy-specific information from headers in the compressed data.

9. The method of claim 1, wherein the proxy dynamically generates new code space if code space does not exist to compress communication from the server to the client.

10. A compression proxy process comprising:
receiving a compressed request from a client, the compressed request including an XML document;
determining if code space corresponding to the XML document is available;
when the proxy has the correct code space, decompressing the XML document;
communicating the decompressed XML document to a specified server;
communicating a server response from the specified server;
determining if code space is available to compress the reply;
if code space is not available to compress the reply, dynamically generating a new code space;
if code space is available to compress the reply or after the new code space is generated, compressing the reply; and
communicating the compressed reply including a code space version or identification header to the client.

11. The process of claim 10, wherein the XML document includes headers, the headers including information on an intended server uniform resource locator (URL).

12. The process of claim 10, wherein if the code space is not available, the server responds to the client with a request for the code space and the client replies with the requested data.

13. The process of claim 10, further comprising stripping proxy-specific header information from the XML document received from the client.

14. A method of communicating documents from a client communicating compressed documents to a server communicating decompressed documents, the method comprising:
communicating a compressed request from a client to a proxy;
decompressing the compressed request at the proxy and communicating the decompressed request to a server;
communicating a response from the server to the proxy;
compressing the response at the proxy and communicating the response to the client;
and processing the response at the client.

15. The method of claim 14, wherein the client is a wireless device.

16. The method of claim 14, wherein the proxy removes any proxy-specific information from headers in the compressed request.

17. The method of claim 14, wherein the proxy dynamically generates new code space if code space does not exist to compress the response from the server.

18. The method of claim 14, wherein the compressed request from the client includes headers having an address of an intended server and a code space.

19. The method of claim 14, wherein the server is a Simple Object Access Protocol (SOAP) server.

20. The method of claim 14, wherein the server services both non-compressed and compressed requests.
